(19) United States
(12) Patent Application Publication
(10) Pub. No.: US 2006/0106155 A1
(43) Pub. Date: May 18, 2006

(54) Phosphite reactions in the presence of metal soaps for liquid stabilisers

(75) Inventors: Charles-Antoine Carraz, Manchester (GB); Susan Patricia Malcomson, Manchester (GB); Malcolm Thomas John Mellor, Lancashire (GB)

Correspondence Address: OLIFF & BERRIDGE, PLC, P.O. BOX 19928, ALEXANDRIA, VA, 22320, US

(73) Assignee: AKZO NOBEL N.V., BM Amhem (NL)

(21) Appl. No.: 10/546,249

(22) PCT Filed: Mar. 23, 2004
(86) PCT No.: PCT/EP04/03067

§ 371 Date: Aug. 19, 2005

(30) Foreign Application Priority Data
Apr. 4, 2003 (EP) 03076007.8

(51) Int. Cl. C08F 214/06

(52) U.S. Cl. 524/567

(57) ABSTRACT

The present invention pertains to a process for the preparation of a liquid stabilizer for imparting heat stability to polyvinyl chloride compositions which is essentially solvent-free, comprising the steps of reacting one or more carboxylic acids with one or more metal sources in the presence of one or more organophospite ester-reactive solvents while stripping off water, wherein the metal in said metal source is selected from the group consisting of Ca, Ba, Zn, Sr, K, and Cd; adding one or more organophosphite esters selected from the group consisting of triorganic phosphites, organic acid phosphites, diphosphites, and polyphosphites, and reacting the one or more organophosphite ester-reactive solvents with said organophosphite esters, while distilling off phenol; and, optionally, adding one or more additives known in the art before, during, or after the addition of the one or more organophosphite esters to the reaction mixture.

The present invention relates to a novel process for the preparation of a liquid stabiliser for vinyl halide polymers comprising one or more organophosphite esters, to the thus obtained liquid stabiliser, to a stabilised vinyl halide polymer comprising said liquid stabiliser, and to shaped articles formed therefrom.

As is generally known, polymers and copolymers of vinyl chloride are utilised for the manufacture of various shaped articles by moulding, extrusion, and casting processes. In these processes high temperatures up to 180-200° C. are required in order to bring the polymer to a sufficiently soft state. At these temperatures, polymers based on vinyl chloride undergo considerable degradation, which results in discolouration and a decrease of their mechanical properties. In order to minimise these adverse changes or effects, stabilisers can be added to the polymer feed. It is generally known that the addition of basic substances, such as lead stearate, calcium stearate or calcium hydroxide, stabilises this type of polymer by inhibiting thermal decomposition. It was found that particularly effective stabilising compounds comprise basic metal soaps of fatty acids. For instance, U.S. Pat. No. 4,102,839 discloses a stabiliser composition imparting heat resistance to vinyl chloride polymers as well as stabilisation against thermal degradation which comprises a divalent metal salt of an organic carboxylic acid and a β-diketone or β-keto-aldehyde.

A possible disadvantage of the use of the above-mentioned metal soap stabilisers is that due to the presence of excess carboxylate, the stabilisers can produce a greater or lesser degree of incompatibility with the vinyl halide polymer during its processing and in the finished vinyl plastic product. This results in migration of unassimilated carboxylate to the surfaces of the vinyl resin compound during curing and processing, which becomes visible by haziness or discolouration of the vinyl plastic. Moreover, undesirable plate-out on the carrying equipment is caused, as well as undesirable scum that exudes on aging or exposure to weathering. It is for instance known from U.S. Pat. No. 2,564,646 or U.S. Pat. No. 3,519,584 that the addition of triorganic phosphites helps to overcome these disadvantages. U.S. Pat. No. 2,564,646 shows that alkyl and aryl triorganic phosphites can be used for this purpose, whereas U.S. Pat. No. 3,519,584 discloses that by incorporation of certain asymmetric alkaline earth metal carboxylate-phosphites into the polymers, the above-mentioned problems can be avoided. A stabiliser composition consisting of an organo tin mercaptide, an organo phosphite, and a zinc salt of carboxylic acid is described in EP 0 211 414. Said composition is described as imparting improved clarity to PVC after incorporation therein.

Generally, metal carboxylate-organophosphite ester stabiliser compositions are prepared in two steps. In a first step, the metal carboxylate salt is prepared, and subsequently the one or more organophosphite ester components are added. The carboxylic acid components of the metal carboxylates are often mixtures of (C₆-C₂₆) aliphatic and (C₇-C₁₉) aromatic acids. The preparation of their salts normally requires the use of a solvent to reduce the viscosity of the salts for ease of handling and to assist with the removal of water from the reaction mixture. The choice of solvent is extremely important, as it is necessary both to maintain a homogeneous mixture during the preparation of the metal carboxylate-organophosphite ester stabiliser and to provide good long-term storage properties for the finished stabiliser. Alcohol solvents frequently satisfy these requirements and are therefore typically employed in the preparation of this type of liquid stabiliser.

The organophosphite ester component of liquid stabilisers is generally prepared by transesterification of a triorganic phosphite or an organic acid phosphite with the desired alcohol, as is known in the art. Suitably, it is formed by transesterification of triphenylphosphite or diphenyl acid phosphite under elimination of phenol in the presence of a base catalyst, according to the following equations:

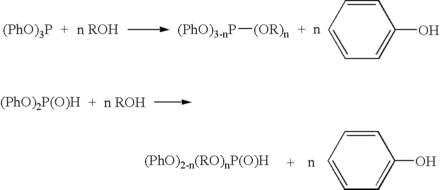

The thus obtained triorganic phosphite and/or organic acid phosphite is added to the metal carboxylate—solvent mixture, providing the desired liquid stabiliser.

An example of a slightly adapted preparation method can be found in WO 96/15186, which relates to liquid stabilisers comprising triorganic phosphites and metal carboxylates. In particular, the liquid stabiliser described in this document comprises barium and zinc, one or more aliphatic carboxylates selected from the group consisting of straight and branched aliphatic saturated and unsaturated carboxylates, one or more aromatic carboxylates containing 8 to 10 carbon atoms, one or more triorganic phosphites, and one or more organic acid phosphites. The most preferred carboxylates are mentioned to include oleate and isomers of octanoate, such as 2-ethyl hexanoate. The most convenient manner to make this stabiliser is disclosed to be admixing, in a first step, the previously prepared barium-zinc-carboxylate salt mixture, the triorganic phosphite(s) which is/are liquid at 20° C., and the organic acid phosphite(s) which is/are liquid at 20° C. Often, an amount of solvent or diluent must be added in order to prevent the mixture from becoming excessively viscous. In a second step, additional solid components such as additional barium and/or zinc carboxylates are added, combined with a certain amount of solvent, preferably isodecyl alcohol and mineral spirits, to provide good mixing. The thus obtained liquid stabiliser composition imparts heat stability to PVC.

The presence of alcoholic solvents in the final stabiliser composition was found to have some major disadvantages. First, they tend to react with the organo-phosphite esters both during the preparation of the stabiliser and during the processing of the vinyl chloride polymer, generating phenol or alkylated phenol components. Alcoholic solvents, phenols, and alkylated phenols all contribute to the amount of undesired volatiles present during the production of the stabiliser as well as during the processing of vinyl chloride polymer and in the final shaped article.

Since there is an increased need for products with low volatility, low phenol level, and low phenol formation, it is an object of the present invention to provide a liquid stabiliser composition which does not introduce volatiles to the vinyl halide products. Furthermore, it is an object of the present invention to provide a liquid stabiliser comprising one or more organophosphite esters and one or more metal carboxylates which has improved stabilising properties.

The objects of the invention are realised by preparing a metal carboxylate-organophosphite ester liquid stabiliser composition via an in-situ preparation process, which means that one or more organophosphite ester components are synthesised in the presence of one or more metal carboxylate components. It is noted that the term organophosphite ester used throughout this document is meant to denominate both triorganic phosphites with the general formula of P(OR)₃, organic acid phosphites with the general formula of (RO)₂P(O)H, and di- and polyphosphites with the general formula of RO—[P(OR)—O—R′—O]ₙ—P(OR)₂, wherein each R is independently selected from the group consisting of a C₇-C₁₈ alkylaromatic group, a linear or branched C₆-C₁₄ aliphatic group, and a phenyl group, R′ may be any conventional bridging group, and n is 1-3,000. In the process according to the present invention, essentially all solvents or diluents which do not contribute to the stabilising effect on the vinyl halide polymer are removed. In this manner, a novel liquid stabiliser composition comprising one or more organophosphite esters and one or more metal carboxylate components is obtained, which is essentially solvent-free and which is effective in enhancing the resistance to heat-mediated deterioration of vinyl halide polymers. Furthermore, it provides the final product with improved clarity.

In more detail, the process according to the present invention for the preparation of a liquid stabiliser which is essentially solvent-free comprises the steps of
reacting one or more carboxylic acids with one or more metal sources in the presence of one or more organophosphite ester-reactive solvents while stripping off water, wherein the metal in said metal source is selected from the group consisting of Ca, Ba, Zn, Sr, K, and Cd;
adding one or more organophosphite esters to the resulting reaction mixture and reacting the organophosphite ester-reactive solvent with said organophosphite esters, while distilling off generated or free aliphatic and/or aromatic alcohols; and,
optionally, adding antioxidants, metal intermediates, costabilisers, PVC acceptable additives, organic acid phosphites, triorganic phosphites and diphosphites or mixtures thereof before, during, or after the addition of the one or more organophosphite esters to the reaction mixture.

Carboxylic acids suitable for use in the process of preparing the liquid stabiliser composition according to the present invention include any conventional acid. Preferably, linear or branched C₆-C₂₆ aliphatic acids and/or C₇-C₁₉ aromatic acids are used. More preferably, the carboxylic acid is selected from the group consisting of benzoic acid, toluic acid, tert-butyl benzoic acid, a C₈-C₁₀ aliphatic acid, and a C₁₈ aliphatic acid. Said aliphatic acids may contain up to 3 double bonds. In the process according to the invention, one or more suitable carboxylic acids can be used. In a particularly preferred embodiment, a mixture of two or more carboxylic acids is employed. These one or more carboxylic acids are mixed with a suitable solvent, or a mixture of suitable solvents. To the resulting reaction mixture, one or more metal sources are added in a conventional amount. Metal sources which are particularly suitable for this purpose include any common salts of Ca, Ba, Zn, Sr, K, and Cd, such as calcium hydroxide, calcium oxide, barium hydroxide, barium oxide, zinc oxide, strontium hydroxide, potassium hydroxide, cadmium oxide, or cadmium hydroxide. In a preferred embodiment, two or more metal sources are used which preferably comprise salts of barium and zinc or calcium and zinc. Upon reaction of the one or more metal sources with the one or more carboxylic acids, water is generated, which is removed from the reaction mixture. The water removal can be accomplished in any conventional way, but preferably by distillation or membrane separation processes.

Suitable solvents for the process according to the present invention are hydroxylic solvents which are able to transesterify organophosphite esters to form different organophosphite esters. Hence, they are called “organophosphite ester-reactive solvents” throughout this specification. A solvent is considered to be able to react with organophosphite esters if in a 50/50 molar mixture of said solvent and said organophosphite ester, in the presence of 1 mol % potassium hydroxide or other suitable catalyst, at least 10 mol % of the solvent has reacted with the organophosphite ester after heating the mixture for 2 hours at 140° C. Conveniently, triphenyl phosphite is used as the organophosphite and KOH as the catalyst if a screening for a suitable solvent is conducted. It is important that these solvents are so low-volatile that they do not come off with the generated water in the first step of the process. It is noted that the term ulow-volatilen therefore denotes solvents having a boiling point higher than water. Preferably, the organophosphite ester-reactive solvent is selected from the group of low-volatile alcohols and glycols. A non-restrictive list of alcohols which may be used includes C₆-C₁₄ straight or branched alcohol, isodecanol, tridecanol, technical mixtures of alcohols, 2-ethyl hexanol, butyldioxitol, methyldioxitol, butylphenol, dibutylphenol, tributylphenol, and 2,4-dicumylphenol. A non-restrictive list of polyols which may be used includes 1,2-ethanediol, 1,3-propanediol, dipropylene glycol, tripropylene glycol, polyethylene glycol, bisphenol A, and bisphenol F. Preferably, the organophosphite ester-reactive solvent is selected from the group consisting of 2-ethylhexanol, isodecanol, and tridecanol. Most preferably, isodecanol or tridecanol is used. In the process according to the invention, a mixture of two or more of the above-mentioned organophosphite ester-reactive solvents can be employed. However, preferably one single solvent is used.

Suitable organophosphite esters for use as a starting material in the process according to the present invention comprise organophosphite esters selected from the group consisting of
triorganic phosphites of the formula (RO)₃P, wherein each R is independently selected from the group consisting of a C₇-C₁₈ alkylaromatic group, a linear or branched C₆-C₁₄ aliphatic group, and a phenyl group;
organic acid phosphites of the formula (RO)₂P(O)H, wherein R has the same meaning as mentioned above; and
diphosphites and polyphosphites of the formula RO—[P(OR)—O—R′—O]ₙ—P—(OR)₂, wherein R has the same meaning as mentioned above, R′ may be any conventional bridging group, and n is 1-3,000, preferably 1-1,000, and most preferably 1-500.

Preferably, the organophosphite ester comprises at least one C₇-C₁₈ alkylaromatic group, but most preferably, the organophosphite ester comprises at least one phenyl group. A non-limiting list of exemplary additional organophosphite esters that can be used in this invention includes tetraphenyl dipropylene-glycol diphosphite, diphenyl pentaerythritol diphosphite, poly-4,4′-isopropylidenediphenol tetraphenol phosphite, and poly(dipropylene glycol) phenyl phosphite. The organophosphite ester is preferably selected from the group consisting of diphenylisodecyl phosphite, phenyldiisodecyl phosphite, trinonylphenyl phosphite, butyldioxityl nonylphenyl phenylphosphite, butyldioxityl dinonylphenyl phosphite, dibutyldioxityl nonylphenyl phosphite, tetraphenyl dipropylene-glycol diphosphite, and diphenyl acid phosphite. In a particularly preferred embodiment, the organophosphite ester added to the one or more metal carboxylate salts is triphenyl phosphite, because it is readily available and inexpensive.

Upon reaction of the one or more organophosphite esters with the one or more organophosphite ester-reactive solvents (i.e. a transesterification reaction), compounds with the general formula of ROH are liberated, wherein R, depending on the organophosphite ester used, is a C₇-C₁₈ alkylaromatic group, a linear or branched C₆-C₁₄ aliphatic group, or a phenyl group. Since, preferably, at least one of the R groups in the organophosphite ester is a C₇-C₁₈ alkylaromatic group, preferably, at least one equivalent of a phenol-derived product is generated. Even more preferably, at least one of the R groups in the organophosphite ester is a phenyl group, which means that in a particularly preferred embodiment, at least one equivalent of phenol is liberated. The removal of the generated aliphatic or aromatic alcohols takes place at a temperature of preferably at least 160° C., more preferably at least 170° C., and most preferably at least 180° C., and at a vacuum of preferably less than 40 mmHg, more preferably less than 25 mmHg, and most preferably less than 20 mmHg. Preferably, the temperature at which essentially all generated aliphatic alcohols, phenol and phenol-derived products are distilled off does not exceed 240° C., more preferably 230° C., and most preferably 210° C. The vacuum preferably is not less than 4 mmHg, more preferably not less than 6 mmHg, and most preferably not less than 8 mmHg. Preferably, if present, excess organophosphite ester-reactive solvent in the stabiliser composition which has not reacted with the organophosphite esters is also removed in this step.

Preferably, at least 70 wt %, more preferably, at least 85 wt %, even more preferably, at least 95 wt %, and most preferably, essentially all organophosphite esters present in the final composition are products of the reaction between the organophosphite ester used as the starting material and the one or more organophosphite ester-reactive solvents. The resulting organophosphite ester components will show very little subsequent transesterification during stabiliser manufacture or storage, as essentially no organophosphite ester-reactive solvent remains, and hence, very little phenol or alkylated phenol will be liberated. Organophosphite esters which are preferably formed in the in-situ process according to the present invention comprise diphenylisodecyl phosphite, phenylisodecyl phosphite, triisodecyl phosphite, and tris(tridecyl)phosphite.

Optionally, antioxidants, metal intermediates, costabilisers, PVC acceptable additives, organic acid phosphites, triorganic phosphites or diphosphites, or mixtures thereof may be added to the liquid stabiliser composition. The addition can take place before, during, or after the addition of the one or more organophosphite esters to the reaction mixture. In a particularly preferred embodiment, the stabiliser composition according to the present invention does not comprise sulphur-containing organo tin compounds.

The liquid stabiliser composition according to the present invention obtainable via the process described above preferably has a viscosity of at most 20 Pa·s, more preferably at most 5 Pa·s, most preferably at most 2.5 Pa·s, at 20° C. in order to facilitate handling. Preferably, the viscosity of the final stabiliser is at least 10 mPa·s, most preferably at least 20 mPa·s.

In the final liquid stabiliser composition, the one or more metal carboxylates are preferably present in an amount of at least 5 wt % based on the total weight of the final liquid stabiliser. More preferably, they are present in an amount of at least 10 wt %, most preferably at least 15 wt %. The maximum amount of the one or more metal carboxylates in the final stabiliser composition preferably is 90 wt %, based on the total weight of the final liquid stabiliser. More preferably, at most 85 wt %, most preferably at most 80 wt % of metal carboxylates is present in the stabiliser composition.

The total amount of organophosphite ester-reactive solvent employed in the process preferably is at least 5 wt %, based on the total weight of organophosphite esters used as the starting material, more preferably at least 10 wt %, and most preferably at least 20 wt %. The maximum amount of organophosphite ester-reactive solvent preferably is 99 wt %, based on the total weight of the organophosphite esters used as the starting material. More preferably, the amount of organophosphite ester-reactive solvent is at most 97 wt %, and most preferably at most 95 wt %, based on the total weight of organophosphate esters used as the starting material.

In a particularly preferred embodiment, 25-100 wt % of the organophosphite ester-reactive solvent(s) will react with the organophosphite ester(s) that is/are added to said organophosphite ester-reactive solvent(s). More preferably, 50-99 wt %, most preferably 75-98 wt % of the organophosphite ester-reactive solvent(s) will react with the organophosphite ester(s) that is/are added to the organophosphite ester-reactive solvent(s). Thus in the final liquid stabiliser nearly all organophosphite ester-reactive solvent will be bound in organophosphite esters, with almost no free solvent remaining. In the most preferred embodiment, essentially all organophosphite ester-reactive solvent will be bound in organophosphite esters, which means that the final liquid stabiliser is essentially solvent-free.

By the term “essentially solvent-free” is meant that the maximum total amount of unreacted organophosphite ester-reactive solvent, preferably alcohol or glycol, which is present in the final stabiliser composition does not exceed 5.0 wt %, based on the total weight of the final liquid stabiliser. More preferably, the maximum total amount of unreacted organophosphite ester-reactive solvent is 2.5 wt % and most preferably 1.0 wt %, based on the total weight of the final liquid stabiliser. Preferably, the amount of phenol or phenol-derived products present in the final stabiliser composition is less than 5.0 wt %, more preferably less than 3.0 wt %, and most preferably less than 2.0 wt %, based on the total weight of the final liquid stabiliser.

The one or more organophosphite esters which are present in the final liquid stabiliser composition are preferably present in an amount of at least 5 wt %, based on the total weight of the final liquid stabiliser. More preferably, they are present in an amount of at least 10 wt %, most preferably at least 15 wt %, based on the total weight of the final liquid stabiliser. The maximum amount of the one or more organophosphite esters in the final stabiliser composition preferably is 95 wt %, based on the total weight of the final liquid stabiliser. More preferably, at most 90 wt % of organophosphite esters is present, most preferably at most 85 wt %.

The liquid stabiliser composition obtainable by the process according to the invention can additionally contain conventional additives such as antioxidants, plasticisers, metal intermediates, costabilisers, triorganic phosphites and diphosphites, organic acid phosphites, lubricants, costabilisers, and the like. Optionally, the final liquid stabiliser is diluted with phthalate ester and/or epoxy compounds or other diluents which are acceptable in the vinyl halide polymer, for example since they are conventionally used plasticisers.

The liquid stabiliser according to the present invention can be blended with vinyl halide polymers in order to improve their heat-stability. Vinyl halide polymers which can be used are any polymer formed at least in part of the recurring group (—CHX——(CH₂)ₙ and having a halide content in excess of 40%. In this formula, n is the number of units in the polymer chain and X is a halide. Preferably, the polymer is a vinyl chloride polymer. The polymer can also be a copolymer of vinyl chloride with other copolymerisable monomers in moderate proportion, such as copolymers of vinyl chloride and vinyl acetate, copolymers of vinyl chloride with maleic or fumaric acids or esters, and copolymers of vinyl chloride with styrene. The stabiliser composition according to the present invention is also effective with mixtures of polyvinyl chloride in major proportion with a minor proportion of other synthetic resins such as chlorinated polyethylene or a copolymer of acrylonitrile, butadiene, and styrene.

The amounts of the liquid stabiliser according to the present invention which are incorporated into the vinyl halide polymers for enhancing the resistance to heat-mediated deterioration and improved clarity are small. Preferably, the liquid stabiliser according to the invention is added to the polymer in an amount of at least 0.1 wt %, based on the total weight of the stabilised polymer. More preferably, the stabiliser is present in an amount of at least 0.5 wt %, and most preferably in an amount of at least 1.0 wt %, based on the total weight of the stabilised polymer. The maximum amount of liquid stabiliser to be added to the vinyl halide polymer preferably is no more than 15 wt %, based on the total weight of the stabilised polymer. More preferably, the amount of liquid stabiliser is at most 10 wt %, most preferably at most 5 wt %, based on the total weight of the stabilised polymer.

From the vinyl halide polymers stabilised with the liquid stabiliser according to the invention, shaped articles with a reduced level of volatiles can be formed. Furthermore, the preparation process provides several unexpected advantages in the performance of the stabiliser. These include increasing the heat stability in some applications and a notable increase in the clarity of the finished polymer article. A further additional benefit can be observed when the stabiliser is used in combination with isocyanate based bonding agents needed to improve the adhesion of PVC plastisols to a fabric substrate, i.e. in the production of coated fabrics such as tarpaulins, conveyor belts, waterproof clothing. In this application the stabiliser and the bonding agent are incorporated into the pasted PVC plastisol prior to the coating process. The isocyanate is extremely reactive and it is a known problem for the PVC processor that the viscosity of the paste will increase on storage and in a relatively short space of time a point will be reached where the paste can no longer be conveniently spread onto the fabric. This is known within the industry as the “pot life” of the plastisol paste. Stabilisers prepared by the process according to the present invention contain reduced amounts of chemical compounds which can react with isocyanates. The result is a marked increase in the “pot life” of the plastisol and improved convenience for the processor.

The present invention is elucidated by means of the following non-limiting Examples.

### EXAMPLE 1

In the following experiment, a liquid stabiliser composition according to the invention was prepared:

A reaction vessel was charged with isodecanol (229.3 g), p-tert-butylbenzoic acid (100 g), and versatic C10 acid (190.7 g). The resulting mixture was heated to 80° C. Zinc oxide (30.0 g) and barium hydroxide octahydrate (145.6 g) were added portionwise and the reaction mixture was then stirred for 30 min. Subsequently, the resulting soap was dehydrated at 110° C. at 15 mmHg and brought under a nitrogen atmosphere. Triphenyl phosphite (449.9 g) was added and the resulting mixture was heated to 140° C. and stirred for 3 hours. Subsequently, the phenol formed in the previous reaction step was slowly removed up to a temperature of 190° C. at 12 mmHg. The reaction mixture was allowed to cool down to 90° C. When the mixture had reached this temperature, butylhydroxytoluene (50 g) and dibenzoyl methane (30 g) were added. Finally, the product was filtered using dicalite.

### COMPARATIVE EXAMPLE 2

In the following experiment, a product of similar composition to the compound prepared in Example 1 was made using existing technology:

A reaction vessel was charged with isodecanol (229.3 g), p-tert-butylbenzoic acid (100 g), and versatic C10 acid (190.7 g). The resulting mixture was heated to 80° C. Zinc oxide (30.0 g) and barium hydroxide octahydrate (145.6 g) were added portionwise and the reaction mixture was then stirred for 30 min. Subsequently, the resulting soap was dehydrated at 110° C. at 15 mmHg and brought under a nitrogen atmosphere. The reaction mixture was allowed to cool down to 90° C. When the mixture had reached this temperature, diphenyl-isodecyl phosphite (313.5 g), butylhydroxitoluene (50 g), and dibenzoyl methane (30 g) were added. Finally, the product was filtered using dicalite.

### EXAMPLES 3 AND 4

The sample compounds obtained according to the procedure described in Examples 1 and 2 were tested in the formulation given below.

Composition A

| | |
|---|---|
| Suspension polymerised PVC resin (K-71) | 100 |
| Diisononyl phthalate | 45 |
| Epoxidised Soybean Oil | 2 |
| Example | 2 |
| Stearic acid | 0.3 |

149.3 g of this mixture were taken for Examples 1 and 2 to make Examples 3 and 4, respectively. The mixtures were mixed by hand before being placed on an oil heated rolling mill under the conditions described in Table 1. After the milling time the samples were removed as sheets. Test pieces of size 500×20 mm were cut from the prepared sheets and placed in a test oven at 185° C. (Mathis Thermotester Type LTE-TSM). The Yellowness Index (YI of the test sample) was determined according to BS2782: Part 5, Method 530A using a Hunterlab Ultrascan XE. The results are shown in Table 2. The Haze was determined by cutting four test pieces of size 70×70 mm and pressing them at 150° C. at 60 psi for 2.5 minutes. The Haze of the pressed plates was measured using a Hunterlab Ultrascan XE. The results are shown in Table 3.

TABLE 1
Mill conditions

| Roll diameter | 152.4 | mm |
|---|---|---|
| Front roll temperature | 164° | C. |
| Back roll temperature | 163° | C. |
| Front roll speed | 40 | rpm |
| Friction ratio | 1:1 | |
| Nip thickness | 0.9 | mm |
| Milling time | 3 | minutes |

TABLE 2
Yellowness

| | Yellowness index after oven test in minutes | | | | | | | | | |
|---|---|---|---|---|---|---|---|---|---|---|
| Example | 0 | 7 | 14 | 21 | 28 | 35 | 42 | 49 | 56 | 63 |
| 3 | 0.1 | 0.7 | 1.1 | 1.3 | 0.9 | 1.0 | 1.3 | 1.4 | 1.6 | 2.3 |
| 4 | 0.3 | 1.0 | 1.0 | 1.1 | 1.0 | 1.5 | 2.2 | 2.7 | 4.1 | 5.6 |

TABLE 3
Haze

| Example | Haze index |
|---|---|
| 3 | 5.7 |
| 4 | 10.0 |

Volatility

In order to measure the volatility of the samples obtained according to the procedures described in Examples 1 and 2, an accurate weight of the compound was placed in a metallic cupola and left in a test oven (Mathis Thermotester Type LTF-ST) at 150° C. for 10 minutes. The compound was allowed to cool in a dessicator for 5 minutes and then weighed. The results are shown in Table 4.

Free Phenol

The amount of phenol present in the samples obtained according to the procedures described in Examples 1 and 2 was measured using HPLC. The results are shown in Table 4.

TABLE 4
Volatility and free phenol

| | % Weight Loss | |
|---|---|---|
| Example | after 10 min | % free phenol |
| 1 | 2.4 | 1 |
| 2 | 12.3 | 3 |

1. A process for the preparation of a liquid stabiliser suitable for imparting heat stability to polyvinyl chloride compositions, which stabiliser is essentially solvent-free, comprising the steps of
(a) reacting one or more carboxylic acids with one or more metal sources in the presence of one or more organophosphite ester-reactive solvents while stripping off water, wherein the metal in said metal source is selected from the group consisting of Ca, Ba, Zn, Sr, K, and Cd;
(b) adding one or more organophosphite esters selected from the group consisting of
triorganic phosphites of the formula (RO)₃P, wherein each R is independently selected from the group consisting of a C₇-C₁₈ alkylaromatic group, a linear or branched C₆-C₁₄ aliphatic group, and a phenyl group;
organic acid phosphites of the formula (RO)₂P(O)H, wherein each R has the same meaning as mentioned above; and
diphosphites and polyphosphites of the formula
RO—[P(OR)—O—R′—O]ₙ—P—(OR)₂, wherein each R has the same meaning as mentioned above, R′ may be any conventional bridging group, and n is 1-3,000,
and reacting the one or more organophosphite ester-reactive solvents with said organophosphite esters, while distilling off generated ROH; and,
(c) optionally, adding antioxidants, metal intermediates, costabilisers, PVC acceptable additives, organic acid phosphites, triorganic phosphites or diphosphites, or mixtures thereof, before, during, or after the addition of the one or more organophosphite esters to the reaction mixture.

2. A process according to claim 1 wherein the organophosphite ester is selected from the group consisting of tetraphenyl dipropylene-glycol diphosphite, diphenyl pentaerythritol diphosphite, poly-4,4′-isopropylidenediphenol tetraphenol phosphite, poly(dipropylene glycol)phenyl phosphite, diphenylisodecyl phosphite, phenyldiisodecyl phosphite, trinonylphenyl phosphite, butyldioxityl nonylphenyl phenylphosphite, butyldioxityl dinonylphenyl phosphite, dibutyldioxityl nonylphenyl phosphite, tetraphenyl dipropylene-glycol diphosphite, diphenyl acid phosphite, and triphenyl phosphite.

3. A process according to claim 1 wherein the organophosphite ester-reactive solvent is selected from the group consisting of low-volatile alcohols and glycols.

4. A process according to claim 3 wherein the organophosphite ester-reactive solvent is selected from the group consisting of linear or branched C₆-C₁₄ alcohols, isodecanol, tridecanol, technical mixtures of alcohols, 2-ethylhexanol, butyldioxitol, methyldioxitol, butylphenol, dibutylphenol, tributylphenol, 2,4-dicumylphenol, 1,2-ethanediol, 1,3-propanediol, dipropylene glycol, tripropylene glycol, polyethylene glycol bisphenol A, and bisphenol F.

5. A process according to claim 1 wherein the carboxylic acid is selected from the group consisting of C₆-C₂₆ aliphatic acids and C₇-C₁₉ aromatic acids.

6. A process according to claim 5 wherein the carboxylic acid is selected from the group consisting of benzoic acid, toluic acid, tert-butyl benzoic acid, a C₈-C₁₆ aliphatic acid, and a C₁₈ aliphatic acid.

7. A process according to claim 1 wherein the resulting liquid stabiliser has a viscosity in the range of 20 mPa·s and 20 Pa·s at 20° C.

8. A liquid stabiliser for imparting heat stability to polyvinyl chloride compositions which is essentially solvent-free and does not comprise sulphur-containing organo tin compounds, obtainable by the process of claim 1.

9. A liquid stabiliser according to claim 8 wherein said stabiliser is diluted with phthalate ester and/or epoxy compounds.

10. A vinyl halide polymer composition comprising the liquid stabiliser according to claim 8.

11. A vinyl halide polymer composition according to claim 10 wherein the vinyl halide polymer is polyvinyl chloride.

12. A shaped article formed of the vinyl halide polymer composition according to claim 10.
